(19) United States
(12) Patent Application Publication
(10) Pub. No.: US 2020/0225004 A1
(43) Pub. Date: Jul. 16, 2020

(54) LASAR TARGET DEVICE AND METHOD

(71) Applicant: Yanlin WU, Xi'an (CN)

(72) Inventor: Yanlin WU, Xi'an (CN)

(73) Assignee: Elite Optoelectronics CO., LTD, Xi'an (CN)

(21) Appl. No.: 16/249,586

(22) Filed: Jan. 16, 2019

(51) Int. Cl. F41G 3/26; H04W 4/80; H04B 1/38; H04B 10/50; G01J 1/42; G01B 11/00

(52) U.S. Cl. CPC F41G 3/2655; H04W 4/80; H04B 1/38; G09G 3/14; G01J 1/4204; G01B 11/002; F41G 3/2694; H04B 10/503

(57) ABSTRACT

Disclosed herein is a laser shooting target based on photoelectric conversion, simulated shooting sound, and voice broadcast. A front panel is the main support structure and includes a target window, a speaker and a light-emitting diode (LED) display window. The covers may be injection molded of nylon or other plastic material. A homogenizing filter of conventional optical design is included to amplify a laser target area for a photoelectric conversion circuit to collect the light (laser) signal, and to filter out any influence of ambient or stray light on the photodetector. A target ring is printed on the target surface for reference for aiming at the time of shooting. The LED display adopts a digital display for showing the results of effective shooting of target rings. The LED display photoelectric conversion circuit are coupled to an MCU processor having processor readable instructions for operation.

### BACKGROUND

Target shooting has a long and noble history in the world of sports. Recently with the reduction in allowable shooting areas, alternative methods for target shooting have been adopted. One of these, light-based or laser-based shooting allows for a light source to be placed in the barrel of a gun and fire a light when the trigger is pulled. With the advent of these shooting alternatives, there is a need for reliable, accurate and smarter targets to measure shooting performance.

### SUMMARY

Disclosed herein is a laser shooting target based on photoelectric conversion, simulated shooting sound, and voice broadcast. The front panel is the main support structure and includes a target window, a speaker and a light-emitting diode (LED) display window. The covers may be injection molded of nylon or other organic plastic or structural material. A homogenizing filter of conventional optical design is included to amplify a laser target area for a photoelectric conversion circuit to collect the optical (laser) signal, and to filter out any influence of ambient or stray light on the photodetector. A target ring is printed on the target surface for reference for aiming at the time of shooting. The LED display adopts a three-digit seven-segment digital display for showing the results of effective shooting of target rings. The LED display photoelectric conversion circuit is coupled to an MCU processor having processor readable instructions for operation.

Some embodiments include an optional bracket which may be installed on the bottom of the target for placing on a tabletop or other platform to increase stability.

Also included in some embodiments is a radio frequency (RF) receiving/ decoding module which includes an RF antenna, a demodulating circuit and a decoding circuit. The RF receiver operates for receiving and performing primary processing of the radio frequency wireless signals transmitted from a remote controller. The signals are decoded and provided to the MCU for processing. A main control printed circuit board (PCB) may be used to mount system components such as a phototransistor array, an array position processing MCU, a master MCU, an audio amplifier circuit, a 7-segment digital display driver and related power management circuitry.

In operation, the phototransistor array senses a laser directed towards the array. The array position processing MCU may be dedicated for reading the position of the photo-transistor array excited by the laser, further processing the number of rings of sensors, and transmitting the loop number data to the main MCU through a system bus. The main control MCU controls the setting commands, the ring number display, and a voice signal. The photo-transistor array may be laid out in a series of rings as a conventional target, packed tightly into a dense 2D array, or other structure as desired. If a densely packed 2D array is used, the rings may be virtual and determined under programmatic control once a light is sensed on one of the phototransistors.

The audio amplifier circuit may be a class D high-efficiency audio amplifier, which amplifies the output “voice” signal of the master MCU and drives the speaker. The digital display driver will drive the output from the master MCU to a display control for visualization by a user.

The remote control transmits the key code by radio frequency or other suitable means, and may include one or more buttons, an encoding module, a radio frequency generating circuit, a modulation circuit, a transmitting antenna and the like.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 is an exploded view of elements of a device according to the present disclosure.

FIG. 2 shows a block diagram including elements that may be used in certain embodiments as described herein.

FIG. 3 shows a software flow chart which may be used in certain embodiments.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### Lexicography

The terms “effect”, “with the effect of (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

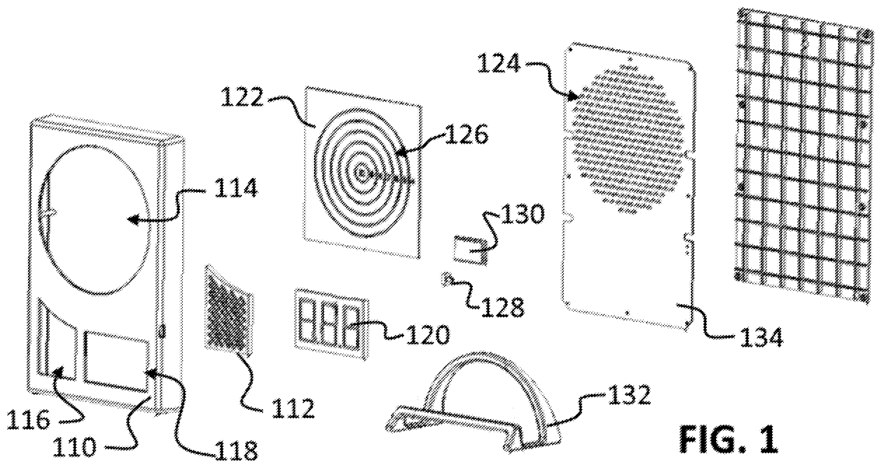

FIG. 1 is an exploded view of elements of a device according to the present disclosure. FIG. 1 shows a front enclosure 110. Closely coupled to the front enclosure 110 is a speaker 112. The front enclosure 110 may be formed from plastic injection molded parts or other suitable material. Also formed into the front enclosure 110 is a target window 114. The front enclosure 110 also includes a speaker window 116 and a display window 118 which allow for audible and visual communications for the user. Coupled to the display window 118 is a display 120 operable for displaying 7-segment display information under control of a process (not shown). Some embodiments may employ alternative displays such as liquid crystal displays (LCD). Also coupled to the front enclosure 110 is the speaker 112 positioned so that audio from the speaker 112 plays through the speaker window 116.

A conventional homogenizing filter 122 is positioned behind the target window 114 to appropriately amplify the area of the laser spot directed through the target window 114 onto a phototransistor array detector 124 and to filter out the influence of the ambient stray light on the detector 124. A homogenizer is an optical device that makes the light beam from a laser or lamp source more uniform in its intensity across its cross-section to enable the light source to provide a more uniform illumination on a surface. Such homogenizers are also called beam homogenizers or beam uniformizers. They divide the light beam cross-section-wise into multiple segments and then overlap these segments of different intensities into a recombined beam of improved uniformity. A variety of optical homogenization devices have been developed, including fly's-eye lens arrays, hollow and solid light tunnels, beam-folding wedged mirrors and split prisms. In some embodiments a target ring 126 may be etched, printed or otherwise disposed on the filter 122.

A radio frequency (RF) receiver module 130 is also enclosed and coupled to a processor (not shown) for receiving control signals from a remote device such as a hand-held controller or remote processor. The RF receiving/decoding module 130 may include a radio frequency receiving antenna, a demodulating circuit and a decoding circuit.

FIG. 1 also shows a power switch 128 is used for power management of the entire system, and an auxiliary bracket 132 of nylon or some other appropriate material. It can be used as the auxiliary part of the laser target. It can be installed on the bottom of the target when it is placed on a tabletop or other platform to increase stability.

The main control printed circuit board (PCB) contains control elements for the present disclosure. It includes a phototransistor array (124), an array position processing controller, a master processor, audio amplifier circuit, 7-segment digital display driver and related power management controls detail herein.

The array position processing controller is operable for reading the position of the phototransistor excited by a laser shot, further processing the number of loops, and transmitting the loop number data to the master processor control through a bus. The main processor also operates with the remote-control setting commands, the ring number display and the voice signal. The audio amplifier circuit may be a class D high-efficiency audio amplifier, which amplifies an output voice signal from the master processor to drive the speaker. The 7-segment digital display driver will make sure the output data of the master processor is displayed in 3-digit 7-segment digital mode, and control the power management for stable and reliable power supply for the device.

A rear cover 136 may also be an injection molded part of nylon or other organic plastic material used to fix other structural parts in the product.

A separate RF remote control module may transmit a key code by radio frequency to operate certain features of the device. The remote control may include buttons, an encoding module, a radio frequency generating circuit, a modulation circuit, and a transmitting antenna. The RF signal may be Bluetooth or other commercially available radio band.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

Embodiments disclosed herein provide for a semiconductor laser and a semi-conductor dot array detector to simulate a bullet shooting and a shooting target. In addition, certain embodiments may include a radio frequency remote controller and an audio broadcast function in the basic function to stimulate product operation.

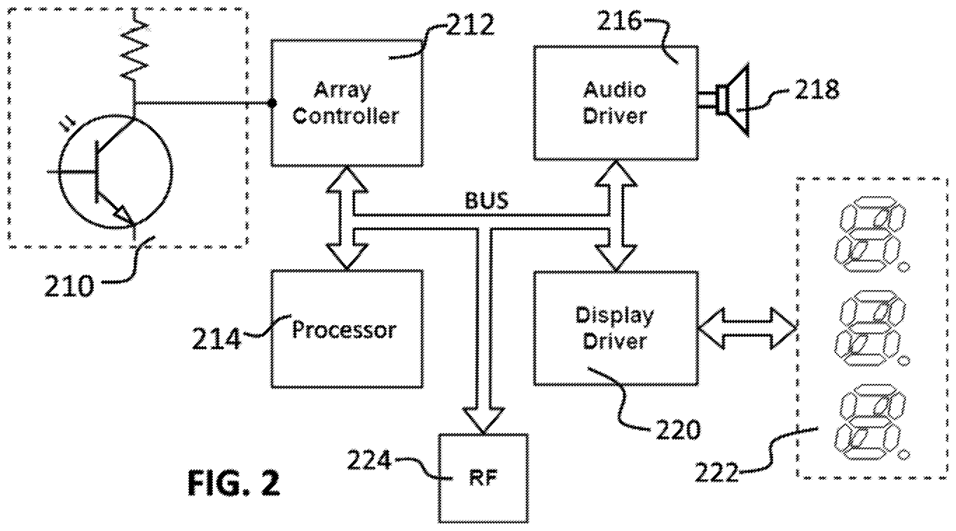

FIG. 2 shows a block diagram including elements that may be used in certain embodiments as described herein. In FIG. 2 an array of photosensors 210, such as phototransistors is depicted coupled to an array controller 212. In certain embodiments the photosensors 210 may be arranged in rings around a center photosensor, thus effectuating a target area. The array controller 212 senses which photosensors received the laser light (or the most laser light if more than one sensor receives light) and sends the identification to the master processor 214 over a communications bus. In some embodiments the array controller may determine which ring was “shot” with a laser and provide that information to the master processor 214.

In response to the information from the array controller 212, the master processor 214 drives the audio circuit 216 and its associated speaker 218 and the display driver 220 and its associated display 222. In operation, the display 220 would indicate which ring (or score) the user hit with the laser device. The audio circuit may also “call out” the score under commands from the processor 214. This may be effectuated by supplying audio information from the master processor 214 to the audio circuit driver 216.

In one embodiment a processing module coupled to photoelectric transducers and audio broadcast circuitry may be employed. This may employ a speaker, a homogenizing filter, an LED (or liquid crystal) light-emitting diode display, and an RF receiving/ decoding module, all coupled to a master controller on a main control PCB. The controllers and processors are coupled to memory for providing processor-readable programming instructions to effect different operations according the present disclosure.

Some embodiments may include a remote controller for resetting the score on the display 222. An RF signal from the remote controller (not shown) would be received at the RF module for coupling to the processor 214. Some embodiments may use different technology to effectuate the remote-control function such as Bluetooth, or infrared (IR) remote controls.

The radio frequency remote controller settings may include command operations including “reset”, “start” and “set” which is controlled by transmitting a key command by the radio frequency remote controller. A voice broadcast function directs the speaker to perform voice broadcast on the number of hit target rings, or accuracy information, and may also perform a real-time shooting sound response every time the laser strikes the target photosensors.

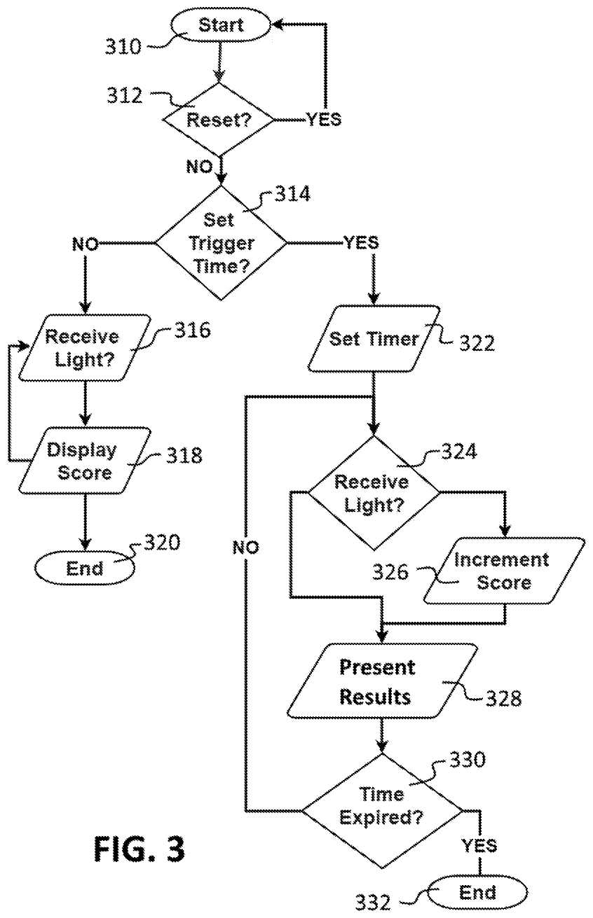

FIG. 3 shows a software flow chart which may be used in certain embodiments. Not every embodiment may use every step and the order of steps may be changed to effectuate design features and alternatives. The method may be stored as processor-readable instructions available to the processor through local memory.

The method begins at a flow label 310. At a step 312 a signal is received from a remote device such as a controller. If the signal is a reset, all timers and counters are set to zero and no action occurs.

If the signal is not a reset, flow proceeds to a step 314 where the signal is analyzed to determine if it is a start signal or a trigger time indication. If it is not a signal to set a trigger time flow it proceeds to a step 316.

At a step 316 the method detects any reception of light on the photosensors. This may be effectuated by polling the array of phototransistors, or by detecting a trigger signal indicating which photosensor received the light. In some embodiments, multiple photosensors may receive a signal, and the photosensors with the largest signal may be selected. Other algorithms may be employed to determine the appropriate photosensor if more than one sensor received a light indication.

At a step 318 a score is displayed. The score may be determined by associating the detected photosensors with its position on the target ring. For example, and without limitation, if the center photosensors receives the most light, the score might be 10, whereas a sensors on an outer ring may only receive a score of 1. Scoring may be cumulative for a series of shots and scoring statistics may be display such as average score, hits and misses, and the like. Signals from a remote controller may be used to control the display to show results.

In addition to displaying a score, audio may be used to indicate results as well. For example, and without limitation, a well-placed shot might produce a louder sound, or the score for the shot may be programmatically played through the audio circuitry. Standard audio sounds may be stored digitally and played through the audio circuits under programmatic control.

After step 318 the play may return to step 316 for another light reception step, or the method may end at a flow label 320.

Returning to step 314, if a trigger time is set, then timing controls may be used to effectuate certain operations. For example, and without limitation, a delayed start time may be set. This allows for a user to set up before timed scoring is performed.

At a step 322 a timer may be set to measure performance over a time setting. In this operation, once a timer is set the flow moves to a step 324.

At a step 324 photosensors are evaluated to see if light has been received on any of them. As described similarly above, this may be effectuated by polling the array of phototransistors, or by detecting a trigger signal indicating which photosensor received the light. In some embodiments, multiple photosensors may receive a signal, and the photosensors with the largest signal may be selected. Other algorithms may be employed to determine the appropriate photosensor if more than one sensor received a light indication.

At a step 326 the score is adjusted depending upon the results from the step 324.

At a step 328 the results of the score are presented to the user. This may be on the 3-digit display, through the audio circuit or a combination of them both.

At a step 330, the timer is checked to see if the timed operation has lapsed. If it has lapsed flow proceeds to a flow label 332 to end. If not, flow proceeds back to the step 324 to await another light incident.

### Alternative Embodiments

Alternative embodiments may provide for different scoring mechanisms. These may include shooting a light source at the target in a predetermined time or calculating scoring parameters such as mean radius or spread, so that a user practicing target shooting gets more information. For example, and without limitation, these alternative embodiments include:
Single shot operation—Report score after every shot without any time limit.
Time limited shooting—Shooting period can be set to a pre-determined time such as 5, 10, 15, 20, or 30 seconds. Reports the score sum at the end of the period.
Shot timer—Random duration to prompt user to shoot. The LED panel and/or voice may prompt the user to shoot. (After detection of the first shot, keep detecting subsequent shots for a period such as 1 second. Display the time and sum the scores.
Shooting period score—Sums up the scores per shooting period. Shooting period is limited by number of shots; 3, 6, 9, 12, or 20 shots.

### Remote Features

In some embodiments, RF circuitry may be wirelessly coupled to a remote controller. The RF operation selected may be a conventional remote controller, or in some embodiments a bi-directional controller. For example, and without limitation, the remote controller may be coupled through Bluetooth.

Remote control operation may include one or more of the following:

Select operation

Add time

Decrease time

Confirm input or start scoring.

In a bi-directional embodiment, the features listed above may be effectuated in addition to more advanced features. The memory may include program instructions directing the processor to send relevant information to a remote controller through the operation of the RF circuitry. This allows reporting of scores to a remote device. The program instructions may expose the operation of the device to allow for remote, programmatic control and measurement of all features. The degree of granularity may be a function of a desired embodiment. In some embodiments the device may perform all operations and the remote device acts as a “dumb” controller, while in other embodiments the remote device performs most functions and the device operates as a limited input/output (I/O) device with very little on-board program control. If the RF circuit is one used with conventional computing devices such as Bluetooth, then applications running on mobile device may be operable to send control signals and to receive scoring results. Accordingly, certain embodiments may expose user controls through a wireless interface and allow for results to be reported remotely.

Wireless control may allow for multiple devices to operate concurrently which may provide for near real-time competitive shooting competitions. Moreover, shooting competitions may be effectuated even if the shooters are not in the same location. The inventor contemplates operations where multiple shooters in different locations, are wirelessly coupled together and certain shooting methods are performed and scored competitively.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A photoreceptor device including:
an array of photosensors, said photosensors coupled to a processor;
a homogenizing filter, said homogenizing filter disposed about the light input portion of the photosensors;
a display coupled to the processor;
an audio circuit coupled to the processor;
a radio frequency transceiver, said transceiver coupled to the processor, and
a memory, said memory coupled to the processor and operable to store non-transitory program instructions directing the processor to perform programmed operations.

2. The device of claim 1 wherein the photosensors are phototransistors and the homogenizing filter is disposed to optimize the illumination surface of the phototransistor.

3. The device of claim 1 wherein the array of photosensors is disposed in rings around a center photosensor.

4. The device of claim 1 wherein the program instructions direct the processor to perform a method of
measuring signals from the photosensors, and
displaying an indicium on the display in response to said measuring.

5. The device of claim 1 further including:
a target ring disposed on a target surface, said target area including the array of photosensors.

6. The device of claim 1 wherein the program instructions include instructions operable to direct the processor to perform a method including the steps of:
exposing a wireless interface, said interface including indicia of sensors illuminated by a light.

7. A method for detecting laser light including:
disposing an array of phototransistors on a surface;
coupling the array to a processor, said processor further coupled to a wireless communications channel
detecting when one or more of the phototransistors is illuminated beyond ambient light level;
transmitting, over the wireless channel, an indicium of the position of the illuminated phototransistors in response to the detecting.

8. The method of claim 7 wherein the wireless channel is Bluetooth.

9. The method of claim 7 wherein a homogenizing filter is disposed on the phototransistors.

10. The method of claim 7 further including:
receiving a signal from the wireless channel instructing the processor to perform a series of timed measurements of the phototransistors and transmit the results of said measurement.

11. The method of claim 7 wherein said detecting includes comparing light signal information from a plurality of illuminated phototransistors to determine which phototransistors received the most illumination.

12. A device for detecting light signals including:
a plurality of optical sensors disposed in a ring array, said sensors coupled to a processor;
a homogenizing filter, said homogenizing filter disposed about the light input portion of the optical sensors;
a radio frequency transceiver, said transceiver coupled to the processor, and
a memory, said memory coupled to the processor and operable to store non-transitory program instructions directing the processor to perform programmed operations.

13. The device of claim 12 wherein the programmed operations include instructions for:
detecting when one or more of the optical sensors is illuminated beyond ambient light level, and
transmitting, over the transceiver, an indicium of the position of the illuminated optical sensor in response to the detecting.
